(19) United States
(12) Patent Application Publication
(10) Pub. No.: US 2002/0116831 A1
(43) Pub. Date: Aug. 29, 2002

(54) Apparatus for releasably retaining a disposable razor cartridge

(76) Inventor: David C. Coffin, Milford, CT (US)

Correspondence Address: Gregg C. Benson, Pfizer Inc., Patent Department, MS 4159, Eastern Point Road, Groton, CT, 06340, US

(21) Appl. No.: 09/796,132

(22) Filed: Feb. 28, 2001

(51) Int. Cl. B26B 21/14

(52) U.S. Cl. 30/526; 30/32

(57) ABSTRACT

In an apparatus for releasably retaining a disposable razor cartridge, a razor handle is provided a portion of which includes an interior area defined by a housing section. A cartridge retainer is at least partially positioned in the interior area and includes a web positioned therein and coupled to the housing section. A pair of the retaining arms each spaced apart form the other project in generally the same direction from the web and include a portion that extends from the housing and terminates in a cartridge engaging end for releasably engaging and retaining a disposable razor cartridge thereon. A plastic hinge is integral with and extends between a pair of retaining arms so that upon exertion of a force thereon in response to a disposable cartridge being pressed against the users skin the web section pivots within the housing section allowing the plastic hinge to deform thereby causing the retaining arms to move relative to one another and the disposable cartridge to pivot and follow the contours of the users skin. Upon removal of the force, the plastic hinge provides a restoring moment to return the web and thereby the disposable cartridge to a neutral position.

### FIELD OF THE INVENTION

The present invention is generally related to razors used in shaving operations, and is more specifically directed to a razor incorporating a mechanism for releasably retaining a disposable razor cartridge.

### BACKGROUND OF THE INVENTION

Modern non-disposable razors used for shaving usually utilize a disposable razor cartridge having one or more razor blades mounted thereon. Generally, these razors employ a handle that incorporates a mechanism for retaining and when desired, releasing the disposable cartridge. Usually the disposable cartridge can pivot relative to the handle so that the blades incorporated therein can follow the contours of a user's skin during a shaving operation.

Ideally, the pivot axis of the cartridge should be at or beneath a plane defined by the surface of the user's skin. However, in order to accommodate the pivoting action of most current disposable cartridges, a physical axle on the cartridge, or recesses that define the cartridge pivot points and are engageable by axle-like retaining members on the razor handle must be provided. Since the geometry of the cartridge dictates the pivot point locations; the pivot axis of the cartridge tends to be located in a less than ideal position.

To allow a user to release a disposable cartridge mounted on the razor handle, as well as to engage and retain a fresh cartridge, a manually manipulable actuator located on the razor handle is generally employed. The actuator, when manipulated to engage a disposable razor cartridge, usually causes one or more retaining members mounted on the handle to move relative thereto. The mechanism for accomplishing this movement in response to manipulation of the actuator has historically been complex requiring several extremely small parts to interact with one another. The tooling for producing and the assembly of these parts can be expensive and time consuming. In addition, the retaining members on prior art razor handles can be quite difficult to align with the mounting recesses or axles on the disposable cartridges making attachment of a fresh disposable cartridge to the handle difficult and frustrating for a user.

Based on the foregoing, it is the general object of the present invention to provide a disposable razor cartridge mounting mechanism that overcomes the problems and drawbacks of prior art mechanisms.

### SUMMARY OF THE INVENTION

The present invention is directed in one aspect to an apparatus for releasably retaining a disposable razor cartridge that includes a razor handle, a portion of which has an interior area defined by a housing section. A cartridge retainer is at least partially positioned in the interior area of the housing section and includes a substantially rigid web pivotally coupled to the housing section. A pair of retaining arms each spaced apart from the other project in generally the same direction outwardly from the web and include a portion that extends from the housing section terminating at a cartridge-engaging end. A plastic hinge positioned in the interior area and extending between the pair of retaining arms is located so as to be between the web and cartridge retaining ends of the retaining arms. Upon exertion of a force on the pair of retaining arms, such as would be generated by pushing a disposable razor cartridge mounted thereon into the skin of a user during a shaving operation, the plastic hinge deforms and the web section pivots. This in turn causes the disposable razor cartridge to rotate about a pivot axis and thereby follow the contours of the users skin. Upon release of the force the plastic hinge provides a restoring moment to return the web and thereby the disposable razor cartridge to a cartridge retaining position.

In the preferred embodiment of the present invention a manual actuator is coupled to the plastic hinge and extends in a direction generally opposite the extension direction of the retaining arms. The actuator is movable between a cartridge engaging and cartridge releasing position that allows the user to disengage or eject the disposable razor cartridge and replace it with a new one. Preferably, the actuator is integral with the cartridge retainer thereby forming a one-piece component.

In the above-described embodiment of the present invention, the plastic hinge includes a pair of guide members which project outwardly from opposing sides thereof and are approximately coaxial with one another. The housing in which the plastic hinge is located includes a pair of opposing slots each adapted to slidably engage one of the guide members such that upon movement of the actuator from the cartridge retaining to the cartridge releasing position the guide members will slide within the slots thereby maintaining the appropriate orientation of the retaining arms.

Preferably, the actuator includes a pair of actuating links each extending from one of the guide members through the housing in a direction generally opposite the cartridge engaging end of the pair of retaining arms. The actuating links terminate in a finger pad to allow a user to easily manipulate the actuator between the cartridge retaining and releasing positions. An advantage of the cartridge retainer being configured in the above described manner is that the shaving plane is either at or beneath the users skin and the disposable razor cartridge pivots about this plane thereby providing a closer more comfortable shave. In another embodiment of the present invention, the actuator and cartridge retainer are separate pieces made from the same or two different materials. However, the invention is not limited in this regard.

### BRIEF DESCRIPTION OF THE DRAWINGS

FIG. 1 is a partial cross-sectional, side elevational view of an embodiment of the apparatus of the present invention.

FIG. 2 is a partial cross-sectional side elevational view of the apparatus of FIG. 1, showing the cartridge retainer of FIG. 1 in a cartridge releasing position.

FIG. 3 is a partial cross-sectional side elevational view of the apparatus of FIG. 1, showing the cartridge retainer of FIG. 1 in a pivoted position.

### DETAILED DESCRIPTION OF THE PREFERRED EMBODIMENT

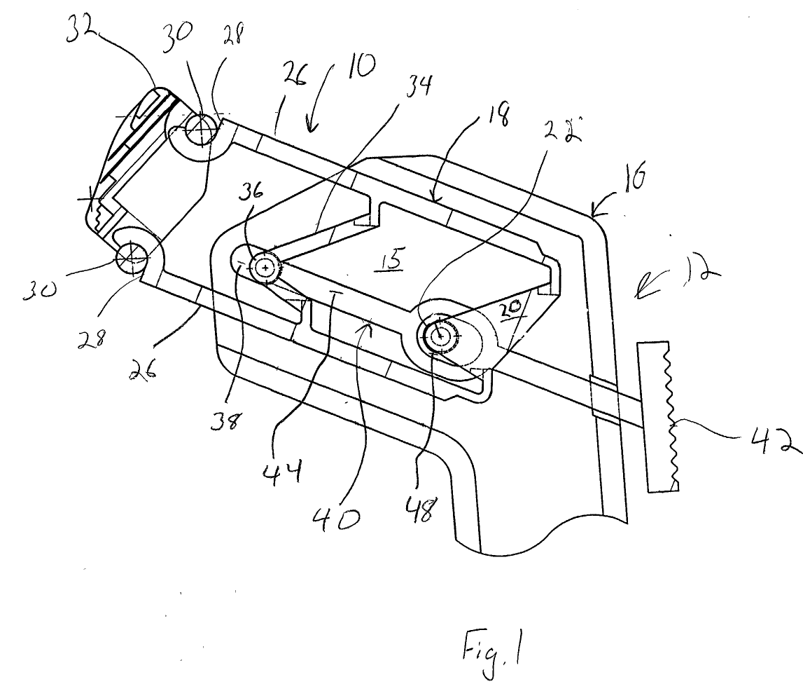

As shown in FIG. 1, a razor for releasably retaining a disposable razor cartridge is generally designated by the reference number 10 and includes a handle generally designated by the reference number 12 that includes a housing section 14. The housing section 14 defines an interior area 15 defined by at least two mating housing section halves 16, (only one shown). Positioned at least partially in the interior area 15 is a cartridge retainer generally designated by the reference number 18. The cartridge retainer includes a substantially rigid web 20 pivotally mounted to housing section halves 16 via a pair of approximately coaxial pivot members 22 each engaged with a mating recess 24 in the respective housing section half 16.

The cartridge retainer 18 also includes a pair retaining arms 26 each extending outwardly, in generally the same direction, from the web 20. A portion of each of the retaining arms 26 also projects outwardly from the housing 16, and terminates in a cartridge engaging end 28 which in the illustrated embodiment is cradle-shaped to engage a complimentarily shaped mounting member 30 forming part of a disposable razor cartridge 32. The cartridge retainer 18 includes a plastic hinge 34 positioned within the interior area 15 between the web 20 and the cartridge engaging ends 28 of the retaining arms 26. The plastic hinge 34 is integral with and extends between the retaining arms 26.

Still referring to FIG. 1, a pair of guide members 36, one shown, each project outwardly from opposing sides of the plastic hinge 34. Each of the guide members slidingly engages a slot 38, the function of which will be explained in detail below, defined by each of the housing sections 16. An actuator generally designated by the reference number 40 extends from the guide members 36, in a direction generally opposite that of the extension direction of the retaining arms 26, through the housing 14 and terminates in a finger pad 42 adapted to be engaged by at least one finger of a user.

The actuator 40 includes a pair of linkage members 44, only one shown, each extending from a respective one of the guide members 36 in a direction generally opposite the extension direction of the retaining arm 26. Each of the linkage members 44 defines an elongated aperture 48 adapted to receive the pivot members 22, leaving clearance therearound. Each linkage member 44 extends through the housing 14 and is attached to the finger pad 42.

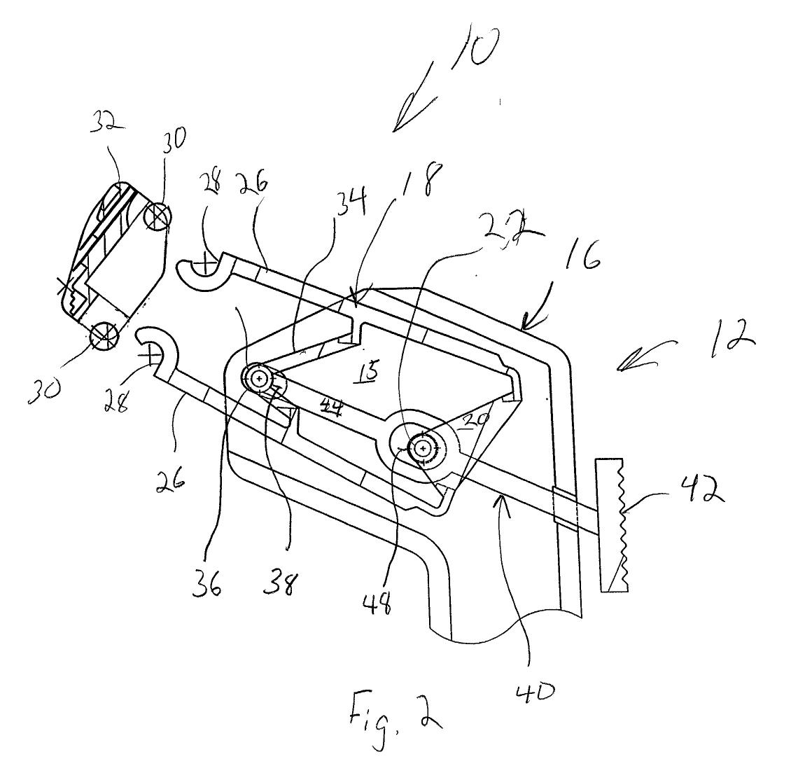

The actuator 40 is movable between a cartridge engaging position as shown in FIG. 1, and a cartridge releasing position, as shown in FIG. 2. Note that the clearance in the aperture 48 allows the actuator 40 to be moved to the cartridge releasing position without the linkage member 44 contacting the pivot member 22. Referring to FIG. 2, moving the actuator 40 from the cartridge retaining position to the cartridge releasing position causes the guide members 36 to slide within the slots 38 which in turn causes the plastic hinge 34 to deform and pull the retaining arms 26 toward each other thereby causing the cartridge engaging ends 28 to move away from, and release the disposable razor cartridge 32 previously retained thereon. To engage a new disposable razor cartridge, the actuator 40 is once again moved to the cartridge releasing position and the cartridge engaging ends 28 are aligned with the mounting members 30 on the disposable razor cartridge. The actuator 40 is then released allowing the plastic hinge 34 to urge the retaining arms 26 back to the cartridge retaining position. Accordingly, the single piece cartridge retainer and actuator function as an asymmetric four bar linkage. Preferably, the cartridge retainer and actuator, 18 and 40 respectively are formed from a suitable material, such as, but not limited to polyethylene, or polypropylene. While the cartridge retainer and actuator, 18 and 40 respectively have been described as being formed into a single piece; the present invention is not limited in this regard as the cartridge retainer and actuator can each be formed from a separate piece and/or from different materials without departing from the broader aspects of the present invention.

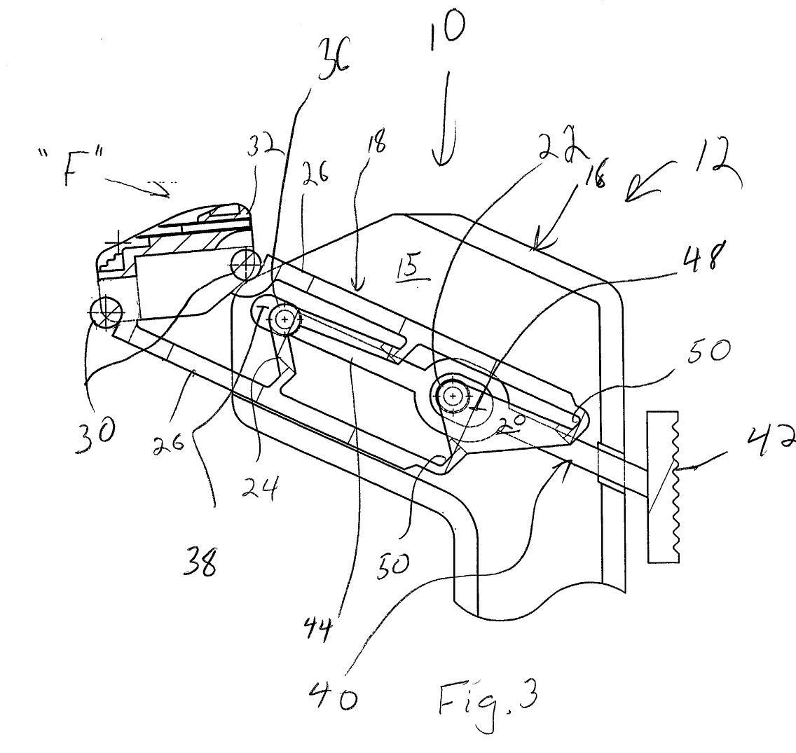

As shown in FIG. 3, the cartridge retainer 18 allows a disposable razor cartridge 32 mounted thereon to pivot relative to a user's skin during a shaving operation. This is due in part to the plastic hinge 34 as well as secondary plastic hinges 50 defined at the junction between the retaining arms 26 and the web 20. During pivoting of the disposable razor cartridge 32, a force “F” exerted on the cartridge 32 causes the retaining arms 26 to move relative to one another. This movement is facilitated by the deformation of the plastic hinge 24, the pivoting or rotation of the web 20 and the deformation of the secondary plastic hinges 50. Upon removal of the force “F”, the plastic hinge 24 biases the disposable razor cartridge 32 back to the unpivoted position.

While preferred embodiments have been shown and described, Various modifications and substitutions may be made without departing from the spirit and scope of the invention. Accordingly, it is to be understood that the present invention has been described by way of example, and not by limitation.

What is claimed is:

1. An apparatus for releasably retaining a disposable razor cartridge comprising:
a razor handle, a portion of which includes an interior area defined by a housing section;
a cartridge retainer at least partially positioned in said interior area and including:
a substantially rigid web positioned within said interior area and pivotally coupled to said housing section;
a pair of retaining arms, each spaced apart from the other and projecting in generally the same direction from said web, each retaining arm including a portion that extends outwardly from said housing section, said portion terminating in a cartridge engaging end for releasably engaging and retaining a disposable razor cartridge thereon;
a plastic hinge, integral with and extending between said pair of retaining arms, so that upon exertion of a force on said pair of retaining arms in response to said disposable razor cartridge being pressed against a user's skin, said web section pivots within said housing section and said plastic hinge deforms causing said retaining arm to move relative to one another and said disposable razor cartridge to pivot and follow the contours of the user's skin; and whereby
said plastic hinge provides a restoring moment to return said web and thereby said disposable razor cartridge to a neutral position upon removal of said force.

2. An apparatus for releasably retaining a disposable razor cartridge as defined by claim 1, further comprising:
an actuator coupled to said plastic hinge and having a portion extending outwardly from said housing in a direction generally opposite the extension direction of said pair of retaining arms, said actuator being movable between a cartridge retaining position and a cartridge releasing position to allow a user to engage and releasably retain or disengage and eject said disposable razor cartridge.

3. An apparatus for releasably retaining a disposable razor cartridge as defined by claim 2 wherein said actuator and said cartridge retainer are a single molded piece.

4. An apparatus for releasably retaining a disposable razor cartridge as defined by claim 1, wherein said web is triangular with each of said arms extending outwardly from a point defined by said triangular shape.

5. An apparatus for releasably retaining a disposable razor cartridge as defined by claim 1, wherein:
said plastic hinge includes a pair of guide members projecting outwardly from opposing sides of thereof, said guide members being approximately coaxial with one another; and
said housing defines a pair of opposing slots each adapted to slidingly receive one of said guide members.

6. An apparatus for releasably retaining a disposable razor cartridge as defined by claim 5, further comprising:
an actuator including a pair of link member each extending from one of said guide members through said housing, generally opposite extension direction of said pair of retaining arms; and
said link members terminating in a finger pad to allow a user to manipulate said actuator between a cartridge retaining and a cartridge releasing position.

7. An apparatus for releasably retaining a disposable razor cartridge as defined by claim 1 wherein:
said disposable razor cartridge is pivotable about an axis at or beneath a plane defined by a user's skin during a shaving operation.

8. An apparatus for releasably retaining a disposable razor cartridge as defined by claim 3 wherein said actuator and said cartridge retainer are polymeric.

9. An apparatus for releasably retaining a disposable razor cartridge as defined by claim 2 wherein said cartridge retainer is made from a first material and said actuator is made from a second material.

10. An apparatus for releasably retaining a disposable razor cartridge as defined by claim 9 wherein said first and second materials are each polymeric.

11. An apparatus for releasably retaining a disposable razor cartridge as defined by claim 1, wherein said cartridge engaging ends of said arms each define a cradle adapted to engage a complementarily shaped portion of said disposable razor cartridge, thereby releasably retaining said razor cartridge on said handle.

12. An apparatus for releasably retaining a disposable razor cartridge as defined by claim 1, wherein said pair of retaining arms each define a junction with said web, each of said junctions forming a secondary plastic hinge.
